(19) United States
(12) Patent Application Publication
(10) Pub. No.: US 2004/0226939 A1
(43) Pub. Date: Nov. 18, 2004

(54) Flexible heating foil

(76) Inventors: Josef Winter, Rohrbach (DE); William H. McNair JR., Piedmont (SC)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/702,500

(22) Filed: Nov. 7, 2003

(30) Foreign Application Priority Data
Nov. 8, 2002 (DE) 202 17 262.7

(51) Int. Cl. H05B 3/34

(52) U.S. Cl. 219/549

(57) ABSTRACT

A flexible heating foil including a flexible support layer on which at least one electrically conductive heating track is arranged between two electrodes. The two electrodes supply the heating track with current. The flexible support layer includes a woven synthetic sheet, on which the at least one heating track is arranged and has one or more slitted areas that serve as expansion joints. The flexible heating foil can be used, for example, as a seat heater in a motor vehicle or as a heating foil to be worn on the body, such as in articles of clothing.

The present invention relates to a flexible heating foil, especially for seat heaters in motor vehicles or as a heating foil to be worn on the body, especially in articles of clothing.

The potential applications for flexible heating foils are manifold. Examples include articles of clothing that keep the wearer's body or body parts warm by means of incorporated, flexible heating foils. In this manner a therapeutic effect, for instance, can be produced, such as is known in so-called heating or rheumatic cushions, in which heat is applied to specific parts of the body by means of a heating foil, which is suitably arranged, for example, in a kidney belt, a joint bandage, a vest, or some similar article.

It is also possible to use articles of clothing with incorporated heating foils that prevent the wearer from becoming too cool in cold weather and/or slipstreams. To accomplish this, for example, motorcycle or convertible drivers may wear appropriate jackets, vests, kidney belts, trousers, or overalls, into which heating foils have been incorporated at appropriate points, which are heated via battery power or the electrical power supply of the motor vehicle.

A further example of a possible application is seat heaters in motor vehicles and on motorcycles.

As with the above-named articles of clothing, the heating foils used here must permit relatively large deformations, perhaps when an article of clothing is put on, or when a person sits down in the seat. For this reason, heating foils of this type must be flexible.

To this end, for example, GM 75 39 613 proposes a conductive dispersion, which is supplied with electrical current via opposing, abutting edges and is thereby heated. The dispersion is enclosed on all sides by electrically insulating material and with this forms a flexible heating foil. However, a heating foil of this type is costly and susceptible to defects in terms of damage to the insulating layer. Furthermore, it necessarily has a substantial thickness, which excludes its use, for example, in thermal bandages to be worn under everyday clothing.

The same is true for the heatable kidney belt proposed in GM 93 19 701, in which a heating wire is arranged in two layers of Neoprene.

Seat heaters are known, for example, from DE 39 38 951 C2, in which ladder-shaped heating tracks are stamped onto a highly permeable, woven or non-woven textile or non-woven material such as “NM-5000”/“20 407FLD” from Nihon Vyliyn/UNITICA, by means of a screen printing process. The disadvantage of this seat heating system, however, is that with a corresponding deformation of the textile fabric, the contact between the fabric and the stamped heating track is somewhat destroyed, and the heating track exposed in this manner is interrupted, especially since the textile fabric is not highly elastic, and greater deformations therefore lead to greater stresses in the fabric. Since the support layer does not give, when someone sits in a correspondingly heated seat, great tensile and shear stresses arise on the surface of the support layer, which adversely affect the connection with the heating tracks. Thus the support layer proposed in DE 39 38 951 C2 is not very flexible, which with prolonged use (continuous sitting down in and getting up out of the seat with the associated stress and deformation) can lead to a failure of the seat heater. For this reason this support layer is also unsuitable for use in articles of clothing, which in some cases undergo considerably greater deformations.

Finally, the process of stamping heating tracks onto a plastic sheet, for example for mirror heaters, is known. In this the plastic sheets, which are produced, for example, via extrusion or some similar process, are relatively inflexible and stiff, For this reason they crackle under the above-described deformations such as arise with heating foils with movement in a seat or in clothing. Furthermore, the stiffness of the sheets produces an uncomfortable rigid feeling. With the creases that form in such sheets, the danger further exists that the stamped heating foils may separate and be interrupted.

The object of the present invention is thus to produce a flexible heating foil in which the above-discussed disadvantages are avoided.

The object is attained with the characterizing features of claim 1.

In a flexible heating foil of the type specified in the invention, one or more electrically conductive heating tracks, which can be supplied with electrical current and thus heated, are arranged on a flexible support layer, which comprises a woven synthetic sheet on which the heating tracks are arranged. The flexible support layer is further equipped with one or more areas containing slits that serve as expansion joints.

The woven synthetic sheet already possesses a high degree of elasticity, so that a heating foil as specified in the invention can be easily shaped, and thus is especially well suited for use in articles of clothing or in seat heating systems. Furthermore, the heating tracks, which are made, for example, of silver, carbon, and/or aluminum, or an alloy of these constituents, and which are preferably arranged on the sheet by means of stamping, adhere particularly well to the textile structure of the synthetic sheet, which prevents separation and a corresponding disconnection in the heating tracks. Finally, due to its textile structure, the synthetic sheet does not possess the disadvantages of traditional synthetic sheets such as crackling, stiffness, and creases.

The deformability of the support layer is expanded considerably by the region with slits that serve as expansion joints. Specifically, no or only slight tensile or shear stresses appear on the surface of the synthetic sheet, which would lead to a degraded adhesion and thus to a separation of the heating tracks to or from the support layer, and to an undesirable deformation of the heating tracks.

Preferably, one or more heating tracks have partially curved, especially meandering and/or sinusoidal sections. In this manner, the surface of the heating track can be enlarged relative to the required support layer surface, thus increasing the heat output density. In addition, such meandering, sinusoidal, or similarly shaped curved sections offer a certain expansion reserve, so that a severe deformation of the heating foil will not result in a tear in the conductor tracks. Advantageously, the slits in the support layer are arranged along the lengthwise and/or crosswise axes of the meandering, sinusoidal, or similarly shaped sections.

In one preferred embodiment, the flexible support layer also comprises a soft layer, especially a foam, textile, or non-woven layer, creating overall a soft, highly cushioned heating foil. In this, the soft layer can preferably be arranged on the side of the heating tracks that is opposite the synthetic sheet, so that the tracks are embedded in a sandwich construction between the soft layer and the synthetic sheet, which serve to protect them.

A heating foil as specified in the invention can be advantageously arranged, for example, in the interior of the passenger compartment of a motor vehicle, especially on a seat and/or armrest surface, on the seat of a motorcycle, or in an article of clothing, especially a jacket, trousers, a vest, overalls, a kidney belt, or a bandage.

Further advantages and characterizing features are disclosed in the sub-claims and in the exemplary embodiments described below. To illustrate these:

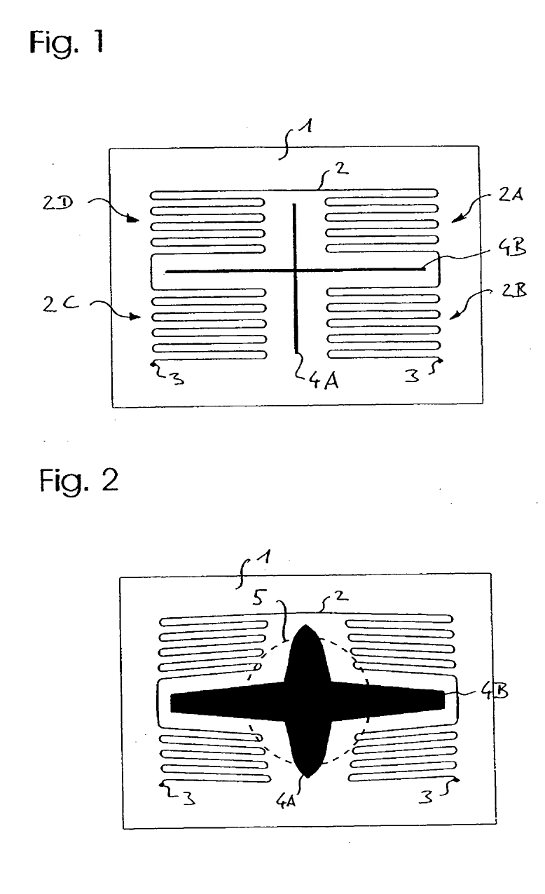

FIG. 1 shows a plan view of a flexible heating foil according to one embodiment of the present invention, in a non-deformed state; and

FIG. 2 shows the heating foil from FIG. 1 in a deformed state.

In FIG. 1, by way of example, a flexible heating foil according to one embodiment of the present invention is represented in a plan view, in a non-deformed state. The heating foil comprises a flexible support layer with a woven synthetic sheet 1, on which an electrically conductive heating track 2 is applied between two electrodes 3 via the impression of silver, carbon, aluminum or a mixture of two or three of these constituents. The woven synthetic sheet 1 may, for example, be the one that is sold under the name “CETUS” by the Dynic firm. The electrodes may be connected to a portable battery or to the electrical system of a vehicle, for example the car battery (not illustrated here), and are heated by means of their electrical resistance when voltage is applied and current begins to flow.

The heating track has four meandering areas 2A, 2B, 2C and 2D. A heating foil as specified in the invention may likewise have sinusoidal or similarly shaped heating track sections. While in this case, by way of example, only one heating track is positioned between the two electrodes 3, several heating tracks may also be arranged between these electrodes 3 or between additional electrodes (not illustrated here).

At the center, the sheet 1 has two slitted areas 4A, 4B, which here, by way of example, are arranged along the lengthwise and/or crosswise axis of the meandering heating track 2. When the heating foil is in a non-deformed state, these slits 4A, 4B are advantageously nearly or completely closed.

FIG. 2 is a schematic representation of the heating foil from FIG. 1, when it is deformed. The deformation here is caused by a ball 5, indicated in the diagram by a dashed line, which is placed at the center of the sheet 1 and is intended to simulate, for example, a passenger sitting down in a seat that is equipped with a heating foil as specified in the invention, or a person bending his elbow while wearing a jacket that contains a heating foil as specified in the invention.

As is evident from FIG. 2, the slits 4A, 4B expand under the strain, thus ensuring a deformation of the sheet 1, without great tensile and shear stresses arising on its surface. At the same time, the fabric structure of the synthetic sheet 1 ensures further elastic deformation.

This deformation characteristic prevents the heating track 2 from separating from the sheet 1 and/or prevents the contact between the sheet 1 and the heating track 2 from deteriorating.

Due to its flexibility, the heating foil specified in the Invention also offers a comfortable feel to the touch and for wearing: When a person sits down or moves in a seat that is equipped with this type of heating foil, or when he wears an article of clothing that is equipped with this type of heating foil, no crackling sounds are produced. Nor does the foil offer the uncomfortable, rigid resistance of conventional synthetic sheets that do not have a fabric structure and slitted areas.

Wearing comfort can advantageously be further increased by the placement of a soft layer made of fabric, non-woven textile, or foam (not illustrated here) on the woven synthetic sheet 1.

As mentioned above, the exemplary embodiment represented here only schematically illustrates the use of a heating foil as specified in the invention. A heating foil of this type can, for example, be positioned on or in the seat, back, or armrest surface, or the door or side panels of a motor vehicle, or the seat of a motorcycle.

A heating foil as specified in the invention may also be placed in a bandage which can then be positioned on the body in such a way that the heat that emanates from the heating foil will produce a therapeutic effect on the corresponding part of the body.

One or more heating foils as specified in the invention may also be arranged in or on articles of clothing, in order to transmit heat to the wearer and prevent him from freezing. Such articles of clothing would be of advantage especially in places where exterior temperatures or high heat transfer coefficients (for example from slipstreams, etc.) prevail, for example with motorcycle or convertible drivers, divers, astronauts, skiers, etc. The voltage that is applied to the electrodes in this case can be generated, for example, by a portable battery, and can advantageously be regulated by a controller such that a constant temperature can be produced in the heating foil.

1. Flexible heating foil with
a flexible support layer, on which at least one electrically conductive heating track (2) is arranged between two electrodes (3), via which the heating track can be supplied with current,
characterized in that
the flexible support layer comprises a woven synthetic sheet (1), on which the at least one heating track (2) is arranged; and
has one or more slitted areas (4A, 4B) that serve as expansion joints.

2. Flexible heating foil in accordance with claim 1, characterized in that several heating tracks are arranged between the two electrodes.

3. Flexible heating foil in accordance with at least one of the preceding claims, characterized in that at least one heating track has partially curved, especially meandering and/or sinusoidal sections (2A, 2B, 2C, 2D).

4. Flexible heating foil in accordance with claim 3, characterized in that the slitted areas (4A, 4B) are arranged in part along the lengthwise and/or crosswise axes of the curved, especially meandering and/or sinusoidal sections (2A, 2B, 2C, 2D).

5. Flexible heating foil in accordance with at least one of the preceding claims, characterized in that the flexible base is equipped with a soft layer, especially a foam, fabric, or non-woven textile layer.

6. Flexible heating foil in accordance with at least one of the preceding claims, characterized in that the heating foil is arranged in the interior of the passenger compartment of a motor vehicle, especially in a seat and/or armrest surface.

7. Flexible heating foil in accordance with at least one of the preceding claims, characterized in that the heating foil is arranged on the seat of a motorcycle.

8. Flexible heating foil in accordance with at least one of the preceding claims, characterized in that the heating foil is arranged in an article of clothing, especially in a jacket, trousers, a vest, overalls, a kidney belt, or a bandage.
